(19) United States
(12) Patent Application Publication
(10) Pub. No.: US 2019/0223233 A1
(43) Pub. Date: Jul. 18, 2019

(54) MULTI-DEVICE COMMUNICATION CONTROL SYSTEM BASED ON EPC TUNNELING AND OPERATION METHOD THEREOF

(71) Applicant: Electronics and Telecommunications Research Institute, Daejeon (KR)

(72) Inventor: Tae Chul Hong, Seoul (KR)

(73) Assignee: Electronics and Telecommunications Research Institute, Daejeon (KR)

(21) Appl. No.: 16/138,583

(22) Filed: Sep. 21, 2018

(30) Foreign Application Priority Data
Jan. 18, 2018 (KR) 10-2018-0006588

(51) Int. Cl. H04W 76/12; H04W 88/16; H04W 80/04; H04W 8/00

(52) U.S. Cl. CPC H04W 76/12; H04W 8/005; H04W 80/04; H04W 88/16

(57) ABSTRACT

Disclosed is multi-device communication system and method based on EPC tunneling. A method of operating a communication control system according to the present disclosure includes: assigning, by a P-GW, an IP address to a first device and a second device being a communication connection target of the first device through LTE initial connection; checking, by first device and the second device, the assigned IP address of each communication connection target device by using a server; determining, by the P-GW, whether or not a destination of a packet received from at least one of the first device and the second device is an EPC internal network; and making, by the P-GW, to an S-GW a request for resetting a tunneling ID of a bearer related to at least one of the first device and the second device according to a result of the determination.

### CROSS REFERENCE TO RELATED APPLICATION

The present application claims priority to Korean Patent Application No. 10-2018-0006588, filed Jan. 18, 2018, the entire contents of which is incorporated herein for all purposes by this reference.

### BACKGROUND OF THE INVENTION

### Field of the Invention

The present disclosure relates a generally to communication control system based on EPC tunneling, and an operation method thereof. More particularly, the present disclosure relates a communication control system reconfiguring EPC tunneling on the basis of eNBs between devices performing data communication using LTE, and a stage of an S-GW, and an operation method thereof.

### Description of the Related Art

Unmanned vehicles mean vehicles that are capable of recognizing external environment, moving by determining the situation itself, and performing work when necessary. Unmanned vehicles are generally capable of detecting and recognizing an external environment, their own momentum, etc., moving themselves and other objects, controlling the vehicle, performing a mission, and interacting with an operator according to a given plan. An unmanned vehicle system (or unmanned system) may classified into, according to an operation environment, an unmanned aerial system (UAS), an unmanned ground system (UGS), an unmanned maritime system (UMS), etc. Meanwhile, an UMS may include operations of all of an unmanned surface vehicle (USV) and an unmanned underwater vehicle (UUV).

As an embodiment of an unmanned vehicle, a drone is a term referring to an unmanned device, and, in order to operate the same, requires a control communication function for operating the drone and a mission communication function for obtaining information such as images, etc. from devices equipped in the drone. Most of drones released to date are equipped with communication technology such as WiFi using the ISM band of 2.4 GHz and 5 GHz band. However, in case of the ISM band, due to the severe interference, it may be used only within a line of sight range. Accordingly, recently, there is an attempt to use mobile communication technologies such as WCDMA and LTE for controlling drones control and for mission communication. In case of the mobile communication, the nationwide network is already installed, and the frequency band is also favorable by using a licensed band.

Meanwhile, a drone and a drone controller (control station) have to receive and transmit data from each other, and thus data communication based on IP is required. Accordingly, when both of the drone and the drone controller use a mobile communication such as LTE, different to conventional mobile communication, user devices have to be connected on the basis of an IP data communication rather than a voice communication. However, in case of an LTE system, a unique phone number is assigned to a subscriber, but an IP address is assigned in an initial access procedure. In addition, within an LTE evolved packet core (EPC), IP routing using an IP address is performed in a packet data network gateway (P-GW) on the basis of tunneling. Accordingly, in order to perform communication while both of the drone and the drone controller use an LTE system, a server is required so that the drone and the drone controller are capable of checking an IP address of the opposite party. In addition, when both of the drone and the drone controller are present in a control area of the same serving gateway (S-GW), routing is performed by passing the P-GW, which is unnecessary, and thus an unnecessary delay time occurs. Particularly, for communication of a drone control, a low delay service is very important. Accordingly, a method of reducing a path within an EPC is required for communication between the drone and the drone controller.

### SUMMARY OF THE INVENTION

Accordingly, the present disclosure has been made keeping in mind the above problems occurring in the related art, and the present invention is intended to provide a multi-device communication control system based on EPC tunneling, and an operation method thereof.

Another object of the present disclosure is to provide a system providing an EPC tunneling method that decreases communication delay time between devices performing data communication using LTE, and an operation method thereof.

It will be appreciated by persons skilled in the art that the objects that could be achieved with the present disclosure are not limited to what has been described hereinabove and the above and other objects that the present disclosure could achieve will be more clearly understood from the following detailed description.

In order to achieve the above object, according to one aspect of the present invention, there is provided a method of operating a communication control system, the method comprising: assigning, by a P-GW, an IP address to a first device and a second device being a communication connection target of the first device through LTE initial connection; checking, by first device and the second device, the assigned IP address of each communication connection target device by using a server; determining, by the P-GW, whether or not a destination of a packet received from at least one of the first device and the second device is an EPC internal network; and making, by the P-GW, to an S-GW a request for resetting a tunneling ID of a bearer related to at least one of the first device and the second device according to a result of the determination.

In the method, the checking of the IP address assigned to each communication connection target device includes: respectively registering, by the server, the IP address assigned to each of the first device and the second device by performing authentication using a unique identifier; and receiving, in at least one of the first device and the second device, an IP address of the other device from the server.

In the method, the determining of whether the destination of the received packet is the EPC internal network includes determining whether or not an IP address of the received packet is an internal IP address of the EPC.

In the method, in the making, by the P-GW, of the request to the S-GW for resetting the tunneling ID of the bearer related to at least one of the first device and the second device according to the result of the determination, the P-GW makes a request to the S-GW for resetting a tunneling ID of the bearer related to an eNB of the communication connection target device when the destination of the received packet is the EPC internal network.

In the method, the making, by the P-GW, of the request to the S-GW for resetting the tunneling ID of the bearer related to at least one of the first device and the second device according to the result of the determination further includes: determining, by the S-GW, whether or not an eNB includes an internal switching function; if so, making, by the S-GW, a request to the eNB for resetting of a tunneling ID of a bearer related to the communication connection target device, and resetting, by the eNB, the tunneling ID in response to the request; and if not, resetting, by the S-GW, the tunneling ID of the bearer related to at least one of the first device and the second device according to the request of the P-GW.

In the method, the making, by the P-GW, to the S-GW of the request for resetting the tunneling ID of the bearer related to at least one of the first device and the second device according to the result of the determination further includes setting a new bearer among a first S-GW and a second S-GW when the first S-GW connected to the first device and the second S-GW connected to the second device differ from each other.

According to another aspect of the present disclosure, there is provided a communication control system, the system comprising: a first device; a second device performing communication connection with the first device; a P-GW assigning an IP address to the device; an S-GW; and a server, wherein the first device and the second device are respectively assigned with an IP address from the P-GW through LTE initial connection, the assigned IP address of each communication connection target device is checked by using the server, and the P-GW determines whether or not a destination of a packet received from at least one of the first device and the second device is an EPC internal network, and makes a request to the S-GW of resetting a tunneling ID of a bearer related to at least one of the first device and the second device according to the determination.

In the apparatus, the server registers the IP address assigned to each of the first device and the second device by performing authentication using a unique identifier, and provides an IP address of the other device in response to a request of the at least one of the first device and the second device.

In the apparatus, the P-GW determines whether or not an IP address of the received packet is an EPC internal IP address.

In the apparatus, the P-GW make a request to the S-GW for resetting a tunneling ID of a bearer related to an eNB of the communication connection target device when the destination of the received packet is the EPC internal network.

In the apparatus, further comprising an eNB, wherein the S-GW determines whether or not the eNB includes an internal switching function, if so, the S-GW makes a request to the eNB for resetting of a tunneling ID of a bearer related to the communication connection target device, and if not, the S-GW resets the tunneling ID of the bearer related to at least one of the first device and the second device in response to the request of the P-GW, and

the eNB resets the tunneling ID in response to the request of the S-GW.

In the apparatus, the P-GW sets a new bearer among a first S-GW and a second S-GW when the first S-GW connected to the first device and the second S-GW connected to the second device differ from each other.

According to the present disclosure, there is provided a multi-device communication control system based on EPC tunneling, and an operation method thereof.

In addition, according to the present disclosure, there is provided a system providing an EPC tunneling method that decreases communication delay time between devices performing data communication using LTE, and an operation method thereof.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing a connection configuration between devices using LTE according to an embodiment of the present disclosure;

FIG. 2 is a view showing a general EPC internal tunneling configuration according to an embodiment of the present disclosure;

FIG. 3 is a view showing an EPC tunneling configuration according to an embodiment of the present disclosure;

FIG. 4 is a view showing an EPC tunneling application where devices are positioned in separate base stations (eNB) according to an embodiment of the present disclosure;

FIG. 5 is a view showing an EPC tunneling application where devices are positioned in a common base station (eNB) according to an embodiment of the present disclosure;

FIGS. 6A and 6B is a view of an EPC tunneling application where devices are positioned in a common base station (eNB) including an internal switching function according to an embodiment of the present disclosure;

FIG. 7 is a view showing an EPC tunneling configuration where connection between S-GWs is available according to an embodiment of the present disclosure;

FIG. 8 is a view showing an EPC tunneling application where devices are present in control areas of separate S-GWs according to an embodiment of the present disclosure; and

FIG. 9 is a view of a block diagram showing a communication control system according to an embodiment of the present disclosure.

### DETAILED DESCRIPTION OF THE INVENTION

Hereinbelow, exemplary embodiments of the present disclosure will be described in detail such that the ordinarily skilled in the art would easily understand and implement an apparatus and a method provided by the present disclosure in conjunction with the accompanying drawings. However, the present disclosure may be embodied in various forms and the scope of the present disclosure should not be construed as being limited to the exemplary embodiments.

In describing embodiments of the present disclosure, well-known functions or constructions will not be described in detail when they may obscure the spirit of the present disclosure. Further, parts not related to description of the present disclosure are not shown in the drawings and like reference numerals are given to like components.

In the present disclosure, it will be understood that when an element is referred to as being “connected to”, “coupled to”, or “combined with” another element, it can be directly connected or coupled to or combined with the another element or intervening elements may be present therebetween. It will be further understood that the terms “comprises”, “includes”, “have”, etc. when used in the present disclosure specify the presence of stated features, integers, steps, operations, elements, components, and/or combinations thereof but do not preclude the presence or addition of one or more other features, integers, steps, operations, elements, components, and/or combinations thereof.

It will be understood that, although the terms “first”, “second”, etc. may be used herein to describe various elements, these elements should not be limited by these terms. These terms are only used to distinguish one element from another element and not used to show order or priority among elements. For instance, a first element discussed below could be termed a second element without departing from the teachings of the present disclosure. Similarly, the second element could also be termed as the first element.

In the present disclosure, distinguished elements are termed to clearly describe features of various elements and do not mean that the elements are physically separated from each other. That is, a plurality of distinguished elements may be combined into a single hardware unit or a single software unit, and conversely one element may be implemented by a plurality of hardware units or software units. Accordingly, although not specifically stated, an integrated form of various elements or separated forms of one element may fall within the scope of the present disclosure.

In the present disclosure, all of the constituent elements described in various embodiments should not be construed as being essential elements but some of the constituent elements may be optional elements. Accordingly, embodiments configured by respective subsets of constituent elements in a certain embodiment also may fall within the scope of the present disclosure. In addition, embodiments configured by adding one or more elements to various elements also may fall within the scope of the present disclosure.

Hereinbelow, exemplary embodiments of the present disclosure will be described in detail with reference to the accompanying drawings. Throughout the drawings, the same reference numerals will refer to the same or like parts.

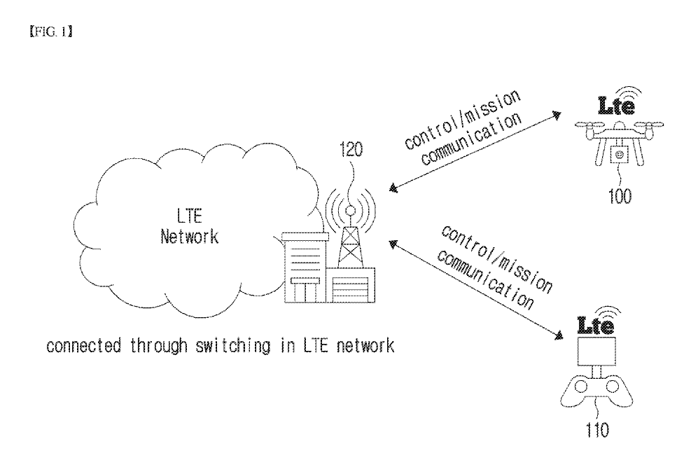

FIG. 1 is a view showing a connection configuration between devices using LTE according to an embodiment of the present disclosure.

Referring to FIG. 1, two devices may be a drone 100 and a drone controller 110, respectively. The drone 100 and the drone controller 110 are equipped with an LTE communication module. When the drone 100 and the drone controller 110 are respectively connected to an LTE base station 120, a communication signal may be transferred to each of the drone 100 and the drone controller 110 by passing an LTE network, that is, evolved packet core (EPC). A communication signal transmitted from each of the drone 100 and the drone controller 110 may be connected by identifying a destination (that is, communication object) in an interior of the EPC.

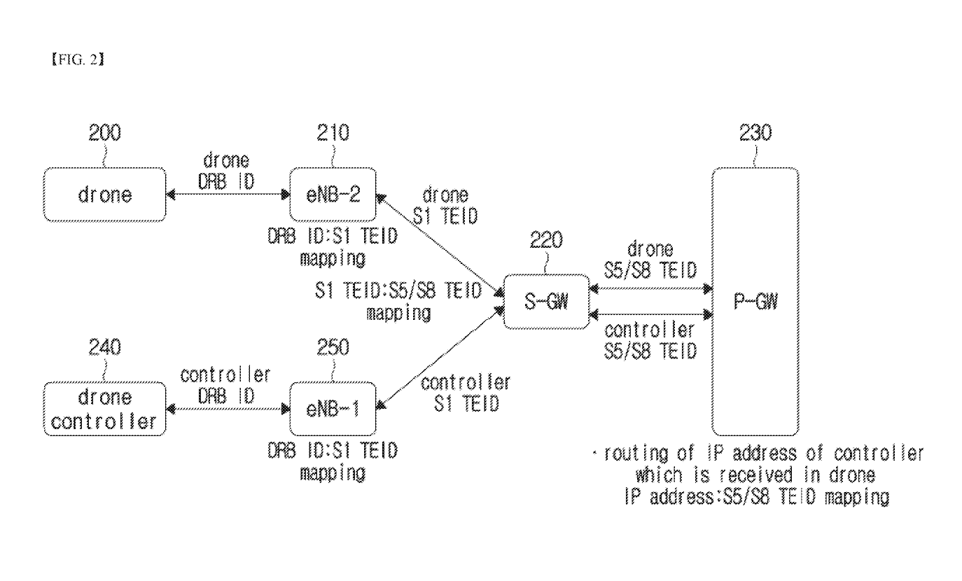

FIG. 2 is a view showing a general EPC internal tunneling configuration according to an embodiment of the present disclosure.

Referring to FIG. 2, a drone 200 and a drone controller 240 are connected to each other by using tunneling on UDP/IP in an internal of an EPC. IP routing using a practical IP address may be performed in a packet data network gateway (P-GW). Accordingly, between the drone 200 and a P-GW 230, and between the drone controller 240 and the P-GW 230, three tunnels are present, respectively. In detail, between the drone 200 and the P-GW 230, a DRB tunnel between the drone 200 and an eNB-2 210, an S1 tunnel between the eNB-2 210 and a serving gateway (S-GW) 220, and an S5/S8 tunnel between the S-GW 220 and the P-GW 230 are present. In addition, between the drone controller 240 and the P-GW 230, a DRB tunnel between the drone controller 240 and an eNB-1 250, an S1 tunnel between the eNB-1 250 and the S-GW 220, and an S5/B8 tunnel between the S-GW 220 and the P-GW 230 are present. In addition, in order to perform tunneling according to traffic, an ID is assigned to each tunnel mapped with traffic, and identification may be performed by using a tunnel endpoint identification (TEID). Communication connection between the drone 200 and the drone controller 240 may be performed in a form of arriving in the P-GW 230 from the drone 200 through three tunnels, determining routing by identifying an IP address in the P-GW 230, and arriving in the drone controller 240 that is a final destination through three tunnels. In addition, alternatively, the communication connection may be performed in a form of arriving in the GW 230 from the drone controller 240 through three tunnels, determining routing by identifying an IP address in the P-GW 230, and arriving in the drone 200 that is a final destination through three tunnels.

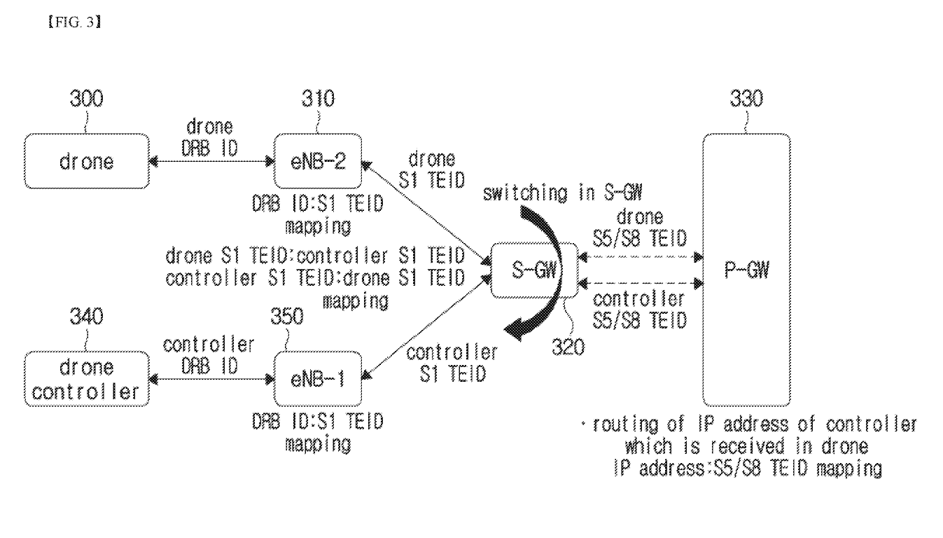

FIG. 3 is a view showing an EPC tunneling configuration according to an embodiment of the present disclosure.

According to the present disclosure, as described in FIG. 2, a tunneling configuration which is connected by using six tunnels may be changed to be connected by using four tunneling to perform switching in an S-GW. Accordingly, by using the changed tunneling configuration changed as the present disclosure, communication delay time between devices may be reduced. Referring to FIG. 3, two devices may be a drone 300 and a drone controller 340, respectively. By using a DRB tunnel between the drone 300 and an eNB-2 310, an S1 tunnel between the eNB-2 310 and an S-GW 320, an S1 tunnel between the S-GW 320 and an eNB-1 350, and a DRB tunnel between the eNB-1 350 and the drone controller 340, the drone 300 and the drone controller 340 may communication with each other.

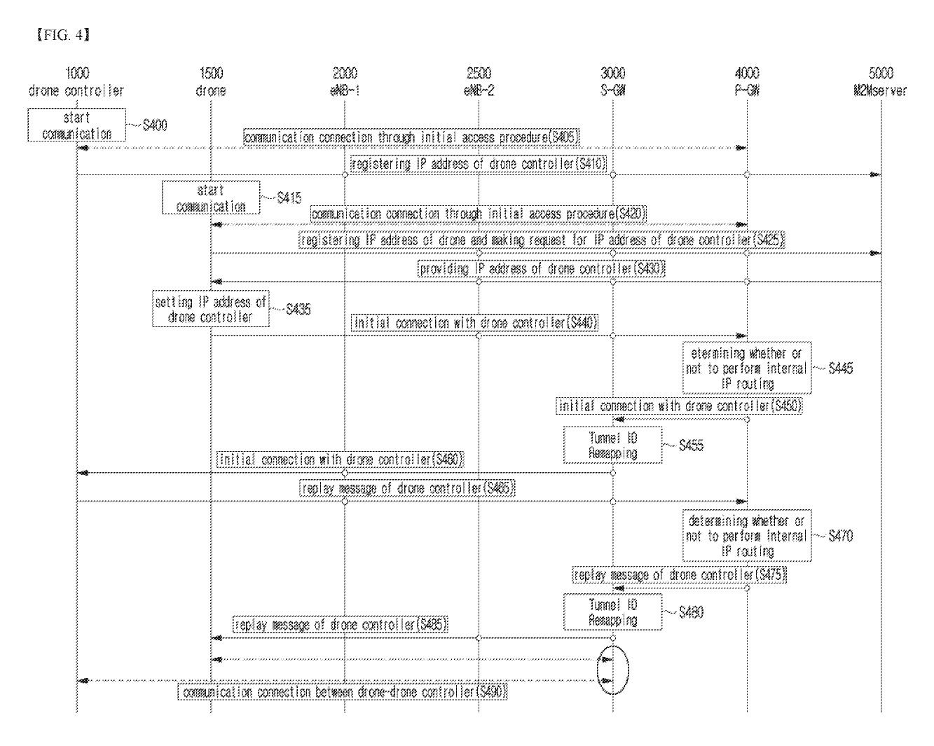

FIG. 4 is a view showing an EPC tunneling application where devices are positioned in separate base stations (eNB) according to an embodiment of the present disclosure.

Referring to FIG. 4, two devices may be a drone controller 1000 and a drone 1500, respectively, and may be connected to separate base stations eNB-1 and eNB-2.

In step S400, the drone controller 1000 may start communication. In step S405, the drone controller 1000 may perform communication connection through an LTE initial access procedure, and may be assigned with an IP address from a P-GW 4000.

In step S410, the drone controller 1000 may make a request for registration of the assigned IP address in an M2M server 5000 so as to perform communication with the drone 1500. The M2M server 5000 may register the IP address of the drone controller 1000 by performing authentication for the drone controller 1000.

In step S415, the drone 1500 may start communication. In step S420, the drone 1500 may perform communication connection through an LTE initial access procedure, and may be assigned with an IP address from a P-GW 4000.

In step S425, the drone 1500 may make a request for registration of the assigned IP address in the M2M server 5000 so as to perform communication with the drone controller 1000, and make a request for the IP address of the drone controller 1000.

In step S430, the M2M server 5000 may register the IP address of the drone 1500 by performing authentication for the drone 1500, and provide the IP address of the drone controller 1000 to the drone 1500.

In step S435, the drone 1500 may register the IP address of the drone controller 1000 received from the M2M server 5000, and make an attempt of initial connection with the drone controller 1000.

In step S440, the drone 1500 may transfer to an eNB-2 2500 an initial connection request message for performing initial connection with the drone controller 1000, and the initial connection request message may be transferred from the eNB-2 2500 to a P-GW 4000 by passing an S-GW 3000.

In step S445, the P-GW 4000 may check an IP address of a packet for IP routing.

When the IP address checked in the P-GW 4000 is an internal IP address of an EPC, in step S450, the P-GW 4000 may determine whether or not a control S-GW for the corresponding IP address is identical, and if so, the P-GW 4000 may transfer to the S-GW 3000 the initial connection request message of the drone 1500 with a tunneling ID update request message so that tunneling ID mapping of the S-GW for corresponding traffic is headed for the eNB-1 2000 that is a destination.

In step S455, the S-GW 3000 may update tunneling ID mapping according to a command of the P-GW 4000.

In step S460, the S-GW 3000 may transfer to the eNB-1 2000 the initial connection request message of the drone 1500, and the initial connection request message may be transferred from the eNB-1 2000 to the drone controller 1000.

In step S465, the drone controller 1000 may transfer to the eNB-1 2000 a reply message, and the reply message may be transferred from the eNB-1 2000 to the P-GW 4000 by passing the S-GW 3000.

In step S470, the P-GW 4000 may check an IP address of a packet for IP routing.

When the IP address checked in the P-GW 4000 is an internal IP address of the EPC, in step S475, the P-GW 4000 may check whether or not a control S-GW for the corresponding IP address is identical, and if so, the P-GW 4000 may transfer to the S-GW 3000 the reply message of the drone controller 1000 with a tunneling ID update request message so that tunneling ID mapping of the S-GW for corresponding traffic is headed to the eNB-2 2500 that is a destination.

In step S480, the S-GW 3000 may update tunneling ID mapping according to a command of the P-GW 4000.

In step S485, the S-GW 3000 may transfer to the eNB-2 2500 the reply message of the drone controller 1000, and the reply message may be transferred from the eNB-2 2500 to the drone 1500.

In step S490, setting EPC tunneling for communication connection between the drone 1500 and the drone controller 1000 may be completed.

Meanwhile, in steps S400 to S420, registering an IP address in the M2M server 5000 by the drone 1500 or the drone controller 1000 is individually performed so that an order thereof is not determined. In addition, as step S425, making a request for an IP address of the other parity after registering the IP address is not essentially performed by the drone 1500, and the drone controller 1000 may make a request for an IP address of the drone 1500.

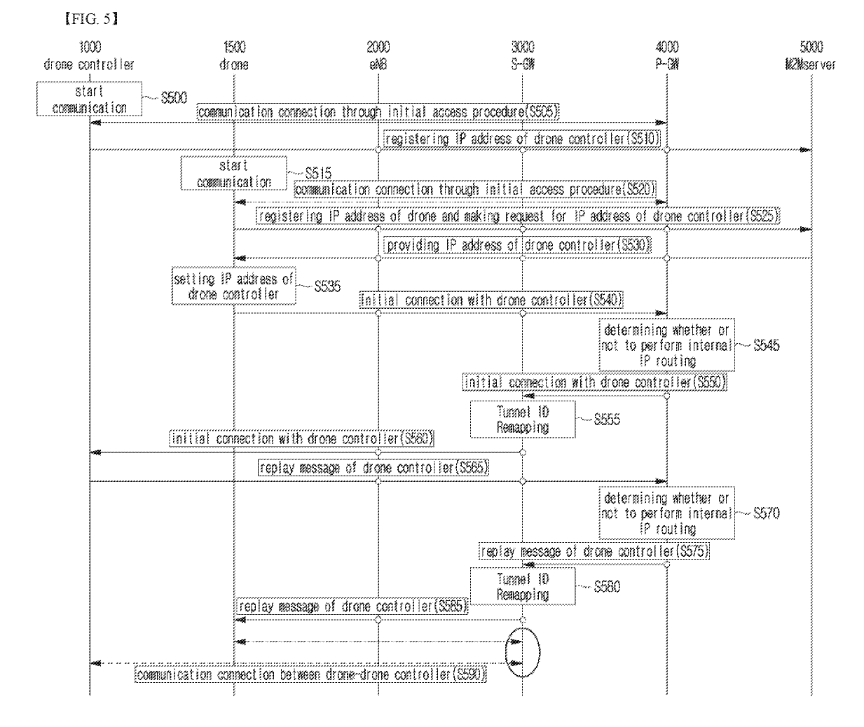

FIG. 5 is a view showing an EPC tunneling application where devices are positioned in a common base station (eNB) according to an embodiment of the present disclosure.

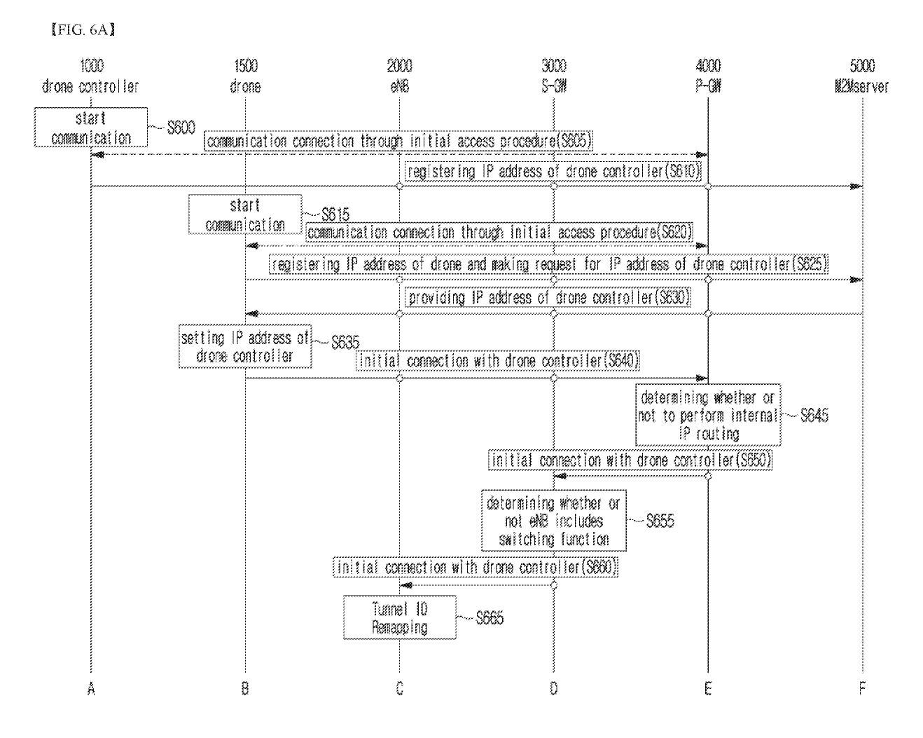

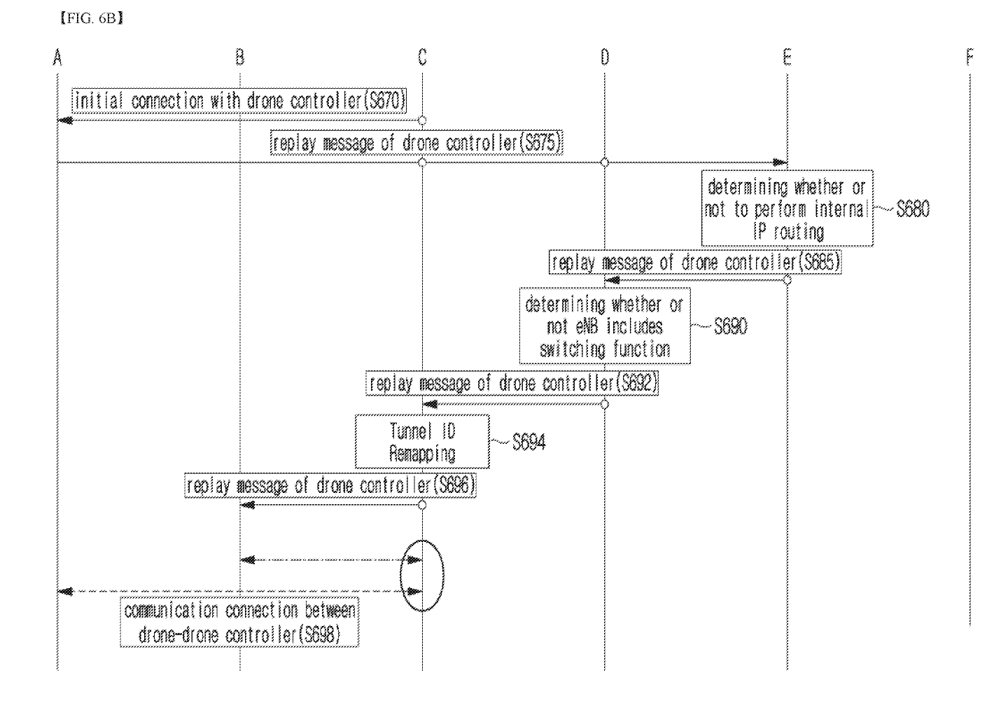

Referring to FIG. 5, two devices may be a drone controller 1000 and a drone 1500, respectively, and may be connected to an identical base station (eNB). Meanwhile, herein, according to whether or not the eNB includes a routing function to another site by including an internal switching function, in addition to steadily transferring data between the mobility management entity (MME) and an S-GW, a tunneling method may vary. In other words, the tunneling method may vary according to whether or not the eNB includes an internal switching function. FIG. 5 is a view of an embodiment when the eNB does not include an internal switching function, and FIGS. 6A and 6B are a view of an embodiment when the eNB includes an internal switching function.

Referring to FIG. 5, a tunneling method may be performed by using a procedure identical to FIG. 4 except that an eNB is provided rather than the eNB-1 and the eNB-2.

In step S500, a drone controller 1000 may start communication. In step S505, a drone controller 1000 may perform communication connection through LTE initial access procedure, and may be assigned with an IP address from a P-GW 4000.

In step S510, the drone controller 1000 may make a request for registration of the assigned IP address in an M2M server 5000 to perform communication with the drone 1500, and the M2M server 5000 may register the IP address of the drone controller 1000 by performing authentication for the drone controller 1000.

In step S515, the drone 1500 may start communication. In step S520, the drone 1500 may perform communication connection through an LTE initial access procedure, and may be assigned with an IP address from a P-GW 4000.

In step S525, the drone 1500 may make a request for registration of the assigned IP address in the M2M server 5000 to perform communication with the drone controller 1000, and for an IP address of the drone controller 1000.

In step S530, the M2M server 5000 may register the IP address of the drone 1500 by performing authentication for the drone 1500, and provide the IP address of the drone controller 1000.

In step S535, the drone 1500 may register the IP address of the drone controller 1000 which is received from the M2M server 5000, and attempt initial connection with the drone controller 1000.

In step S540, the drone 1500 may transfer to an eNB 2000 an initial connection request message for initial connection with the drone controller 1000, and the initial connection request message may be transferred from the eNB 2000 to the P-GW 4000 by passing the S-GW 3000.

In step S545, the P-GW 4000 may check an IP address of a packet for IP routing.

When the IP address checked in the P-GW 4000 is an internal IP address of the EPC, in step S550, the P-GW 4000 may determine whether or not a control S-GW for the corresponding IP address is identical, and if so, the P-GW 4000 may transfer to the S-GW 3000 the initial connection request message of the drone 1500 with a tunneling ID update request message so that tunneling ID mapping of the S-GW for corresponding traffic is headed for the eNB 2000 that is a destination.

In step S555, the S-GW 3000 may update tunneling ID mapping according to a command of the P-GW 4000.

In step S560, the S-GW 3000 may transfer to the eNB 2000 the initial connection request message of the drone 1500, and the initial connection request message is transferred from the eNB 2000 to the drone controller 1000.

In step S565, the drone controller 1000 may transfer to the eNB 2000 a reply message, and the reply message may be transferred from the eNB 2000 to the P-GW 4000 by passing the S-GW 3000.

In step S570, the P-GW 4000 may check an IP address of a packet for IP routing.

When the IP address checked in the P-GW 4000 is an internal IP address of the EPC, in step S575, the P-GW 4000 may determine whether or not a control S-GW for the corresponding IP address is identical, and if so, the P-GW 4000 may transfer to the S-GW 3000 the reply message of the drone controller 1000 with a tunneling ID update request message so that tunneling ID mapping of the S-GW for corresponding traffic is headed for the eNB 2000 that is a destination.

In step S580, the S-GW 3000 may update tunneling ID mapping according to a command of the P-GW 4000.

In step S585, the S-GW 3000 may transfer to the eNB 2000 the reply message of the drone controller 1000, and the reply message may be transferred from the eNB 2000 to the drone 1500.

In step S590, setting EPC tunneling for communication connection between the drone 1500 and the drone controller 1000 may be completed.

Meanwhile, in steps S500 to S520, registering an IP address in the M2M server 5000 by the drone 1500 or the drone controller 1000 is individually performed, and thus an order thereof is not determined. In addition, as step S525, making request for an IP address of the other parity after registering the IP address is not essentially performed by the drone 1500, and the drone controller 1000 may make a request for an IP address of the drone 1500.

FIGS. 6A and 6B are a view of an EPC tunneling application where devices are positioned in a common base station (eNB) including an internal switching function according to an embodiment of the present disclosure.

Referring to FIGS. 6A and 6B, a tunneling method may be performed by using a procedure identical to FIG. 4 except that an eNB is set to perform tunneling IP mapping update by determining whether or not the eNB has a switching function in an S-GW.

Referring to FIGS. 6A and 6B, two devices may be a drone controller 1000 and a drone 1500, respectively.

In step S600, the drone controller 1000 may start communication. In step S605, the drone controller 1000 may perform communication connection through an LTE initial access procedure, and may be assigned with an IP address from a P-GW 4000.

In step S610, the drone controller 1000 may make a request for registration of the assigned IP address in the M2M server 5000 for communication with the drone 1500, and the M2M server 5000 may register the IP address of the drone controller 1000 by performing authentication for the drone controller 1000.

In step S615, the drone 1500 may start communication. In step S620, the drone 1500 may perform communication connection through an LTE initial access procedure, and may be assigned with an IP address from a P-GW 4000.

In step S625, the drone 1500 may make a request for registration of the assigned IP address in the M2M server 5000 for communication with the drone controller 1000, and for an IP address of the drone controller 1000.

In step S630, the M2M server 5000 may register the IP address of the drone 1500 by performing authentication for the drone 1500, and provide to the drone 1500 the IP address of the drone controller 1000.

In step S635, the drone 1500 may register the IP address of the drone controller 1000 which is received from the M2M server 5000, and attempt initial connection with the drone controller 1000.

In step S640, the drone 1500 may transfer to an eNB 2000 an initial connection request message for initial connection with the drone controller 1000, and the initial connection request message may be transferred from the eNB 2000 to the P-GW 4000 by passing the S-GW 3000.

In step S645, the P-GW 4000 may check an IP address of a packet for IP routing.

When the IP address checked in the P-GW 4000 is an internal IP address of an EPC, in step S650, the P-GW 4000 may determine whether or not a control S-GW for a corresponding IP address is identical, if so, the P-GW 4000 may transfer to the S-GW 3000 the initial connection request message of the drone 1500 with a tunneling ID update request message so that tunneling ID mapping of the S-GW for corresponding traffic is headed for the eNB 2000 that is a destination.

In step S655, the S-GW 3000 may determine whether or not the eNB 2000 includes a switching function.

When the eNB 2000 includes a switching function, in step S660, the S-GW 3000 may transfer to the eNB 2000 the initial connection request message of the drone 1500 with the tunneling ID update request message.

In step S665, the eNB 2000 may update tunneling ID mapping according to a command of the P-GW 4000.

In step S670, the eNB 2000 may transfer to the drone controller 1000 the initial connection request message of the drone 1500.

In step S675, the drone controller 1000 may transfer to the eNB 2000 a reply message, and the reply message may be transferred from the eNB 2000 to the P-GW 4000 by passing the S-GW 3000.

In step S680, the P-GW 4000 may check an IP address of a packet for IP routing.

When the IP address checked in the P-GW 4000 is an internal IP address of the EPC, in step S685, the P-GW 4000 may determine whether or not a control S-GW of a corresponding IP address is identical, and if so, the P-GW 4000 may transfer to the S-GW 3000 the reply message of the drone controller 1000 with a tunneling ID update request message so that tunneling ID mapping of the S-GW for corresponding traffic a headed for the eNB 2000 that is a destination.

In step S690, the S-GW 3000 may determine whether or not the eNB 2000 includes a switching function.

When the eNB 2000 includes a switching function, in step S692, the S-GW 3000 may transfer to the eNB 2000 the initial connection request message of the drone 1500 with the tunneling ID update request message.

In step S694, the eNB 2000 may update tunneling ID mapping according to a command of the P-GW 4000.

In step S696, the eNB 2000 may transfer to the drone 1500 the reply message of the drone controller 1000.

In step S698, setting EPC tunneling for communication connection between the drone 1500 and the drone controller 1000 may be completed.

Meanwhile, in steps S600 to S620, registering an IP address in the M2M server 5000 by the drone 1500 or the drone controller 1000 is individually performed so that an order thereof is not determined. In addition, as step S625, making request for an IP address of the other parity after registering the IP address is not essentially performed by the drone 1500, and the drone controller 1000 may make a request for an IP address of the drone 1500.

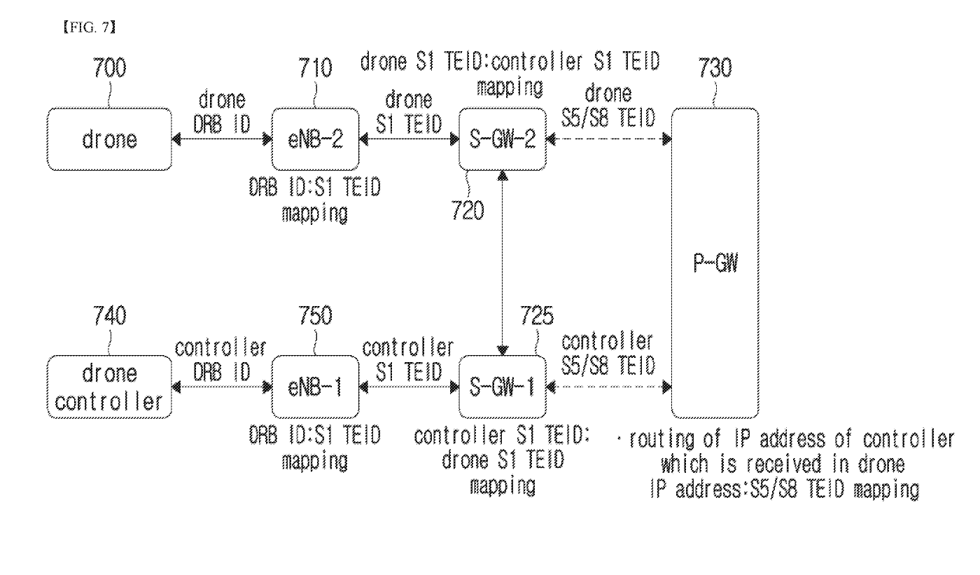

FIG. 7 is a view showing an EPC tunneling configuration where connection between S-GWs is available according to an embodiment of the present disclosure.

Devices may be positioned control areas of S-GWs which are different from each other rather than in an identical control area of an S-GW. Herein, according to the present disclosure, a tunneling configuration between devices may be changed by using tunneling that is directly connected between an S-GW-1 and an S-GW-2. Accordingly, by using a tunneling configuration changed as the present disclosure, a communication delay time between devices may be reduced. Referring to FIG. 7, two devices may be a drone 700 and a drone controller 740, respectively. The drone 700 and the drone controller 740 may communicate with each other by using a DRB tunnel between the drone 700 and an eNB-2 710, an S1 tunnel between the eNB-2 710 and an S-GW-2 720, a tunnel between the S-GW-2 720 and an S-GW-1 725, an S1 tunnel between the S-GW-1 725 and an eNB-1 750, and a DRB tunnel between the eNB-1 750 and the drone controller 740.

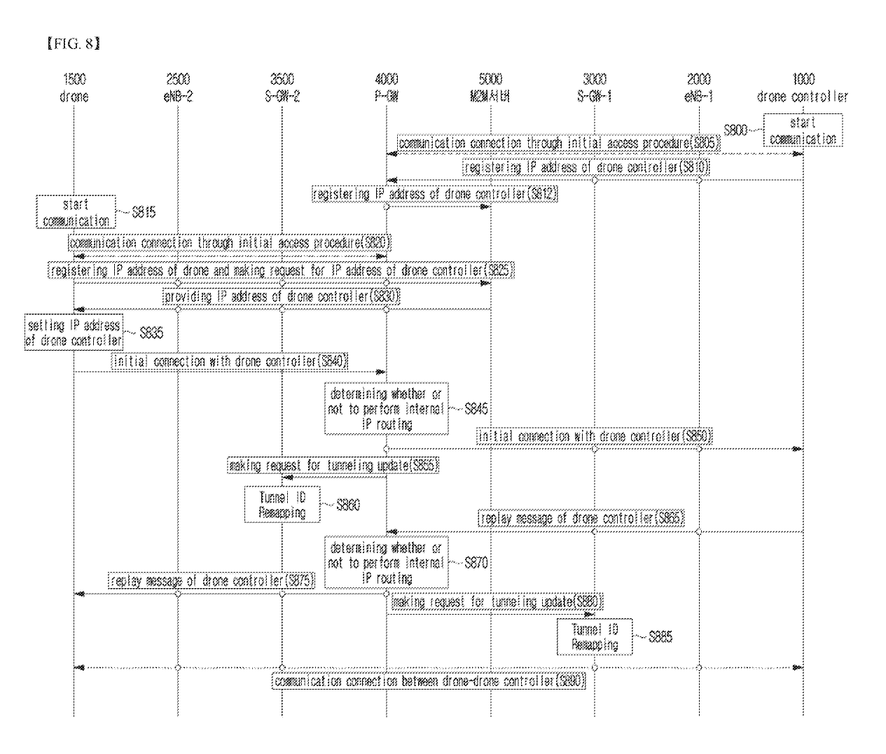

FIG. 8 is a view showing an EPC tunneling application where devices are present in control areas of separate S-GWs according to an embodiment of the present disclosure;

Referring to FIG. 8, a tunneling method may be performed by using a procedure identical to FIG. 4 except that mapping is performed while an S-GW is divided into an S-GW-1 and an S-GW-2.

In step S800, a drone controller 1000 may start communication. In step S805, the drone controller 1000 may perform communication connection through an LTE initial access procedure, and may be assigned with an IP address from a P-GW 4000.

In steps S810 and S812, the drone controller 1000 may make a request for registration of the assigned IP address in the M2M server 5000 for communication with the drone 1500, and the M2M server 5000 may register the IP address of the drone controller 1000 by performing authentication for the drone controller 1000.

In step S815, the drone 1500 may start communication. In step S820, the drone 1500 may perform communication connection through LTE initial access procedure, and may be assigned with an IP address from a P-GW 4000.

In step S825, the drone 1500 may make a request for registration of the assigned IP address in the M2M server 5000 for communication with the drone controller 1000, and for an IP address of the drone controller 1000.

In step S830, the M2M server 5000 may register the IP address of the drone 1500 by performing authentication for the drone 1500, and provide to the drone 1500 the IP address of the drone controller 1000.

In step S835, the drone 1500 may register the IP address of the drone controller 1000 which is received from the M2M server 5000, and attempt initial connection with the drone controller 1000.

In step S840, the drone 1500 may transfer to an eNB-2 2500 an initial connection request message for initial connection with the drone controller 1000, and the initial connection request message may be transferred from the eNB-2 2500 to the P-GW 4000 by passing an S-GW-2 3500.

In step S845, the P-GW 4000 may check an IP address of a packet for IP routing.

When the IP address checked in the P-GW 4000 is an internal IP address of an EPC, in step S850, the P-GW 4000 may determine a control S-GW (that is, S-GW-1 3000) for a corresponding IP address, and transfer to the S-GW-1 3000 the initial connection request message of the drone 1500. The S-GW-1 3000 may transfer to the eNB-1 2000 the initial connection request message of the drone 1500, and the initial connection request message may be transferred from the eNB-1 2000 to the drone controller 1000.

In step S855, the P-GW 4000 may transfer to an S-GW-2 3500 a tunneling ID update request message so that tunneling ID mapping is headed for the S-GW-1 3000 that is a destination.

In step S860, the S-GW-2 3500 may update tunneling ID mapping according to a command of the P-GW 4000.

In step S865, the drone controller 1000 may transfer to the eNB-1 2000 a reply message, and the reply message may be transferred from the eNB-1 2000 to the P-GW 4000 by passing the S-GW-1 3000.

In step S870, the P-GW 4000 may check an IP address of a packet for IP routing.

When the IP address checked in the P-GW 4000 is an internal IP address of an EPC, in step S875, the P-GW 4000 may determine a control S-GW (that is, S-GW-2 3500) for a corresponding IP address. When the control S-GW is the S-GW-2 3500, the P-GW may transfer to the S-GW-2 3500 the reply message of the drone controller 1000, and the S-GW-2 3500 may transfer to the eNB-2 2500 the reply message of the drone controller 1000. The reply message may be transferred from the eNB-2 2500 to the drone 1500.

In step S880, the P-GW 4000 may transfer to the S-GW-1 3000 a tunneling ID update request message so that tunneling ID mapping is headed for the S-GW-2 3500 that is a destination.

In step S885, the S-GW-1 3000 may update tunneling ID mapping according to a command of the P-GW 4000.

In step S890, setting EPC tunneling for communication connection between the drone 1500 and the drone controller 1000 may be completed.

Meanwhile, in steps S800 to S820, registering an IP address in the M2M server 5000 by the drone 1500 or the drone controller 1000 is individually performed so that an order thereof is not determined. In addition, as step S825, making request for an IP address of the other parity after registering the IP address is not essentially performed by the drone 1500, and the drone controller 1000 may make a request for an IP address of the drone 1500.

In addition, meanwhile, according to an embodiment, tunneling ID updating in the S-GW-1 3000 and the S-GW-2 3500 may include bearer setting among the S-GW-1 3000 and the S-GW-2 3500.

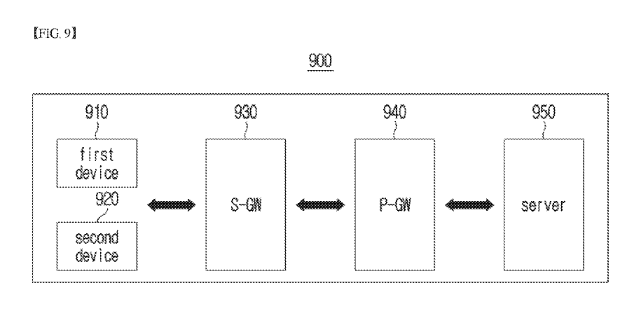

FIG. 9 is a view of a block diagram showing a communication control system according to an embodiment of the present disclosure.

Referring to FIG. 9, a communication control system 900 may include at least one of a first device 910, a second device 920, an S-GW 930, a P-GW 940, and a server 950. However, only some components necessary for describing the present embodiment are shown, and configuration components included in the communication control system 900 are not limited to the above examples.

A communication control system 900 according to an embodiment may include a first device 910, a second device 920 performing communication connection with the first device 910, a P-GW 940 assigning an IP address to a device, an S-GW 930, and a server 950. The first device 910 and the second device 920 may be respectively assigned with an IP address from the P-GW 940 through LTE initial connection. The IP address assigned to each communication connection target device may be checked by using the server 950. The P-GW 940 may determine whether or not a destination of a packet received from at least one of the first device 910 and the second device 920 is an EPC internal network. According to the determination, resetting of a tunneling ID of a bearer related to at least one of the first device 910 and the second device 920 may be requested to the S-GW 930.

In addition, the server 950 may register the IP address assigned to each of the first device 910 and the second device 920 by performing authentication using a unique identifier, and provide an IP address of the other device to a device which has requested for an IP address in response to the request of at least one of the first device 910 and the second device 920.

In addition, the P-GW 940 may determine whether or not the IP address of the received packet is an internal IP address of the EPC.

In addition, the P-GW 940 may make a request for resetting a tunneling ID of a bearer related to an eNB of a communication connection target device to the S-GW 930 when the destination of the received packet is the EPC internal network.

In addition, the P-GW 940 may set a new bearer among a first S-GW and a second 2 S-GW when the first S-GW connected to the first device 910 and the second S-GW connected to the second device 920 differ from each other.

In addition, the communication control system 900 of the present disclosure may further include an eNB (not shown). The S-GW 930 according to an embodiment may determine whether or not the eNB includes an internal switching function, and if so, the S-GW 930 may make a request for resetting a tunneling ID of a bearer related to a communication connection target device to the eNB. If not, the S-GW 930 may reset a tunneling ID of a bearer related to at least one of the first device 910 and the second device 920 according to a request of the P-GW 940.

In addition, the eNB may reset a tunneling ID of a bearer related to a communication connection target device when the S-GW 930 makes a request for resetting a tunneling ID of a bearer related to a communication connection target device.

Although exemplary methods of the present disclosure are described as a series of operation steps for clarity of a description, the present disclosure is not limited to the sequence or order of the operation steps described above. The operation steps may be simultaneously performed, or may be performed sequentially but in different order. In order to implement the method of the present disclosure, additional operation steps may be added and/or existing operation steps may be eliminated or substituted.

Various embodiments of the present disclosure are not presented to describe all of available combinations but are presented to describe only representative combinations. Steps or elements in various embodiments may be separately used or may be used in combination.

In addition, various embodiments of the present disclosure may be embodied in the form of hardware, firmware, software, or combination thereof. When the present disclosure is embodied in a hardware component, it may be, for example, an application specific integrated circuit (ASIC), a digital signal processor (DSP), a digital signal processing device (DSPD), a programmable logic device (PLD), a field programmable gate array (FPGA), a general processor, a controller, a microcontroller, a microprocessor, etc.

The scope of the present disclosure includes software or machine-executable instructions (for example, operating systems (OS), applications, firmware, programs) that enable methods of various embodiments to be executed in an apparatus or on a computer, and a non-transitory computer-readable medium storing such software or machine-executable instructions so that the software or instructions can be executed in an apparatus or on a computer.

What is claimed is:

1. A method of operating a communication control system, the method comprising:
assigning, by a P-GW, an IP address to a first device and a second device being a communication connection target of the first device through LTE initial connection;
checking, by first device and the second device, the assigned IP address of each communication connection target device by using a server;
determining, by the P-GW, whether or not a destination of a packet received from at least one of the first device and the second device is an EPC internal network; and
making, by the P-GW, to an S-GW a request for resetting a tunneling ID of a bearer related to at least one of the first device and the second device according to a result of the determination.

2. The method of claim 1, wherein the checking of the IP address assigned to each communication connection target device includes:
respectively registering, by the server, the IP address assigned to each of the first device and the second device by performing authentication using a unique identifier; and
receiving, in at least one of the first device and the second device, an IP address of the other device from the server.

3. The method of claim 1, wherein the determining of whether the destination of the received packet is the EPC internal network includes determining whether or not an IP address of the received packet is an internal IP address of the EPC.

4. The method of claim 1, wherein in the making, by the P-GW, of the request to the S-GW for resetting the tunneling ID of the bearer related to at least one of the first device and the second device according to the result of the determination, the P-GW makes a request to the S-GW for resetting a tunneling ID of the bearer related to an eNB of the communication connection target device when the destination of the received packet is the EPC internal network.

5. The method of claim 1, wherein the making, by the P-GW, of the request to the S-GW for resetting the tunneling ID of the bearer related to at least one of the first device and the second device according to the result of the determination further includes:
determining, by the S-GW, whether or not an eNB includes an internal switching function;
if so, making, by the S-GW, a request to the eNB for resetting of a tunneling ID of a bearer related to the communication connection target device, and resetting, by the eNB, the tunneling ID in response to the request; and
if not, resetting, by the S-GW, the tunneling ID of the bearer related to at least one of the first device and the second device according to the request of the P-GW.

6. The method of claim 1, wherein the making, by the P-GW, to the S-GW of the request for resetting the tunneling ID of the bearer related to at least one of the first device and the second device according to the result of the determination further includes setting a new bearer among a first S-GW and a second S-GW when the first S-GW connected to the first device and the second S-GW connected to the second device differ from each other.

7. A communication control system, the system comprising:
a first device;
a second device performing communication connection with the first device;
a P-GW assigning an IP address to the device;
an S-GW; and
a server, wherein
the first device and the second device are respectively assigned with an IP address from the P-GW through LTE initial connection, the assigned IP address of each communication connection target device is checked by using the server, and the P-GW determines whether or not a destination of a packet received from at least one of the first device and the second device is an EPC internal network, and makes a request to the S-GW of resetting a tunneling ID of a bearer related to at least one of the first device and the second device according to the determination.

8. The system of claim 7, wherein the server registers the IP address assigned to each of the first device and the second device by performing authentication using a unique identifier, and provides an IP address of the other device in response to a request of the at least one of the first device and the second device.

9. The system of claim 7, wherein the P-GW determines whether or not an IP address of the received packet is an EPC internal IP address.

10. The system of claim 7, wherein the P-GW make a request to the S-GW for resetting a tunneling ID of a bearer related to an eNB of the communication connection target device when the destination of the received packet is the EPC internal network.

11. The system of claim 7, further comprising an eNB, wherein the S-GW determines whether or not the eNB includes an internal switching function, if so, the S-GW makes a request to the eNB for resetting of a tunneling ID of a bearer related to the communication connection target device, and if not, the S-GW resets the tunneling ID of the bearer related to at least one of the first device and the second device in response to the request of the P-GW, and
the eNB resets the tunneling ID in response to the request of the S-GW.

12. The system of claim 7, wherein the P-GW sets a new bearer among a first S-GW and a second S-GW when the first S-GW connected to the first device and the second S-GW connected to the second device differ from each other.
